(19) United States
(12) Patent Application Publication
(10) Pub. No.: US 2016/0216579 A1
(43) Pub. Date: Jul. 28, 2016

(54) LIQUID CRYSTAL DISPLAY AND MANUFACTURING METHOD THEREOF

(71) Applicant: Samsung Display Co., Ltd, Yongin-si (KR)

(72) Inventors: Eun Je JANG, Hwaseong-si (KR); Sung In RO, Hwaseong-si (KR); Woong Ki JEON, Yongin-si (KR)

(21) Appl. No.: 15/003,547

(22) Filed: Jan. 21, 2016

(30) Foreign Application Priority Data
Jan. 22, 2015 (KR) 10-2015-0010710

(51) Int. Cl. G02F 1/1343; G02F 1/1362; G02F 1/1333

(52) U.S. Cl. CPC G02F 1/134309; G02F 1/133345; G02F 1/136286; G02F 1/13439; G02F 2001/136295

(57) ABSTRACT

A liquid crystal display and a manufacturing method that allows a common electrode and a pixel electrode to be formed on one substrate without increasing the number of masks is presented. The liquid crystal display includes a substrate, a gate line and a first electrode (e.g., a common electrode) formed on the substrate, a gate insulating layer formed on the gate line and the first electrode, a second electrode (e.g., a pixel electrode) formed on the gate insulating layer, and a passivation layer formed on the gate insulating layer to overlap the openings of the second electrode. The method entails forming the common electrode below a gate insulating layer, forming the pixel electrode immediately on the gate insulating layer, and forming a passivation layer at a position that does not overlap the pixel electrode.

### CROSS-REFERENCE TO RELATED APPLICATION

This application claims priority to and the benefit of Korean Patent Application No. 10-2015-0010710 filed in the Korean Intellectual Property Office on Jan. 22, 2015, the entire content of which is incorporated herein by reference.

### BACKGROUND

(a) Technical Field

The present invention relates to a liquid crystal display and a manufacturing method thereof.

(b) Description of the Related Art

A liquid crystal display, which is one of the most common types of flat panel displays currently in use, is a display device that applies voltages to electrodes to rearrange liquid crystal molecules of a liquid crystal layer so that an amount of light transmitted may be adjusted.

The liquid crystal display offers a number of advantages including thinness. However, it is not without drawbacks, one of which is that visibility from the sides is lower compared with front visibility. In order to overcome this drawback, various types of liquid crystal arrangements and driving methods are being developed. As a means for implementing a wide viewing angle, a liquid crystal display in which a pixel electrode and a common electrode are formed on a single substrate has attracted attention.

As such, different types of photomask are required to form a common voltage line, a pixel electrode, and a common electrode on one substrate, thereby increasing manufacturing cost.

The above information disclosed in this Background section is only for enhancement of understanding of the background of the invention and therefore it may contain information that does not form the prior art that is already known in this country to a person of ordinary skill in the art.

### SUMMARY

The present inventive concept has been made in an effort to provide a liquid crystal display and a manufacturing method thereof, having advantages of being capable of preventing an increase in a manufacturing cost while forming two field generating electrodes on one substrate.

An exemplary embodiment provides a liquid crystal display including: a substrate; a gate line and a first electrode formed on the substrate; a gate insulating layer formed on the gate line and the first electrode; a second electrode formed on the gate insulating layer, and including a plurality of openings and a plurality of branch electrodes that are defined by the openings; and a passivation layer formed on the gate insulating layer to overlap the openings of the second electrode.

The liquid crystal display may further include: a data line, a source electrode, and a drain electrode formed on the gate insulating layer; a first driving signal line formed at a same layer as that of the gate line; and a second driving signal line formed at a same layer of the data line, and the second driving signal line may be directly connected to the first driving signal line through a first contact hole formed at the gate insulating layer.

The liquid crystal display may further include a protective member formed on the second driving signal line, and formed at a same layer as that of the second electrode.

The liquid crystal display may further include a common voltage line formed on the substrate, the second electrode may be formed on a portion of the drain electrode, and the first electrode may be formed on the common voltage line.

The liquid crystal display may further include: a data line, a source electrode and a drain electrode formed on the gate insulating layer; and a common voltage line formed on the substrate, wherein the gate insulating layer includes a first contact hole extending to the first electrode and a second contact hole extending to the common voltage line, the drain electrode is connected to the first electrode through the second contact hole, and the second electrode is connected to the common voltage line through the third contact hole.

An exemplary embodiment provides a manufacturing method of liquid crystal display, including: forming a gate line and a first electrode on a substrate; forming a gate insulating layer on the gate line and the first electrode; forming a second electrode on the gate insulating layer, the second electrode including a plurality of openings and a plurality of branch electrodes that are defined by the openings; and forming a passivation layer on the gate insulating layer to overlap the openings of the second electrode.

The forming of the second electrode and the forming of the passivation layer may be performed by using one photosensitive film pattern.

The forming of the second electrode and the forming of the passivation layer may include disposing a conductive layer on the gate insulating layer; forming a photosensitive film pattern on the conductive layer; forming the second electrode by etching the conductive layer with the photosensitive film pattern as a mask; disposing a passivation layer on the photosensitive film pattern; and removing the photosensitive film pattern and the passivation layer formed on the photosensitive film pattern.

The manufacturing method may further include: forming a data line, a source electrode, and a drain electrode on the gate insulating layer; forming a first driving signal line at a same layer as that of the gate line; and forming a second driving signal line at a same layer as that of the data line, and the forming of the gate insulating layer may include forming a first contact hole to partially expose the first driving signal line, and the second driving signal line may be directly connected to the first driving signal line through the first contact hole.

The manufacturing method may further include forming a protective member on the second driving signal line and at a same layer as that of the second electrode.

According to the exemplary embodiment of the present invention, it is possible to provide a liquid crystal display and a manufacturing method thereof, capable of preventing an increase in a manufacturing cost while forming two field generating electrodes on one substrate.

### BRIEF DESCRIPTION OF THE DRAWINGS

FIG. 1 is a layout view of a liquid crystal display according to an exemplary embodiment of the present inventive concept;

FIG. 2 is a layout view of a display region of the liquid crystal display of FIG. 1;

FIG. 3 is a layout view of a peripheral region of the liquid crystal display of FIG. 1;

FIG. 4 is a cross-sectional view taken along a line IV-IV′ of FIG. 2 and a line IV″-IV′″ of FIG. 3;

FIGS. 5, 6, 7, 8, 9, 10, 11, 12, and 13 are stepwise cross-sectional views illustrating a manufacturing method of a liquid crystal display according to an exemplary embodiment of the present inventive concept, along the line IV-IV′ of FIG. 2 and the line IV″-IV′″ of FIG. 3;

FIG. 14 is a layout view of a liquid crystal display according to an exemplary embodiment of the present inventive concept; and

FIG. 15 is a cross-sectional view illustrating the liquid crystal display of FIG. 14, taken along a line XV-XV.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the present inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

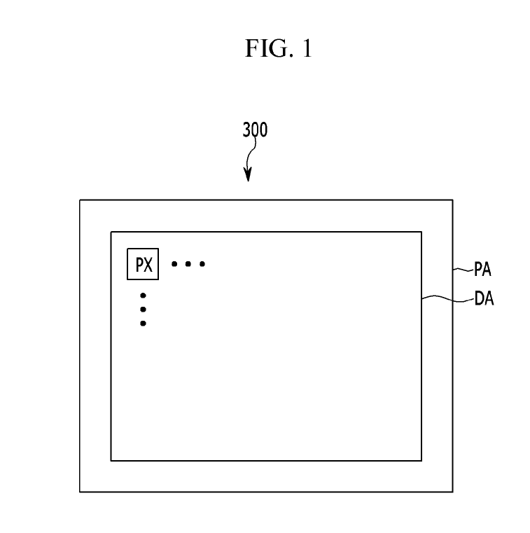

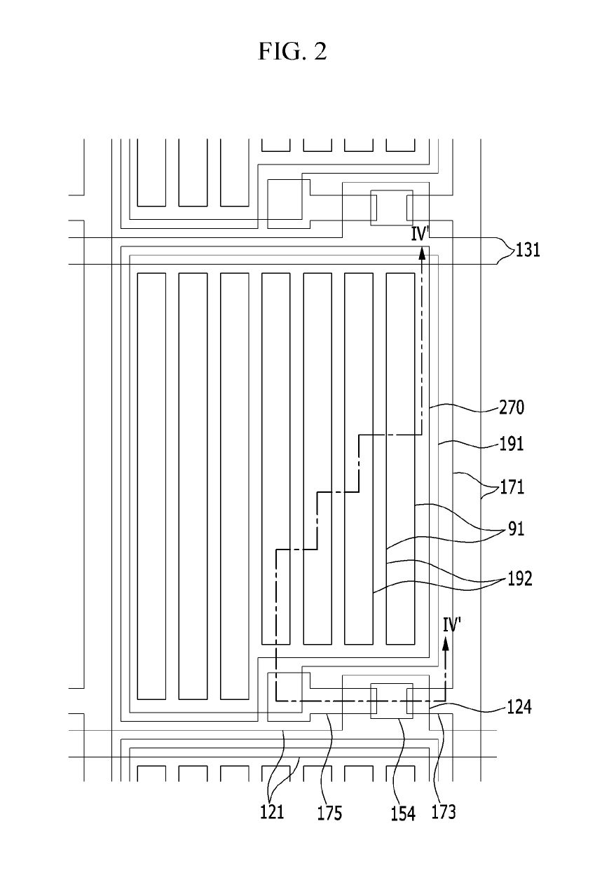

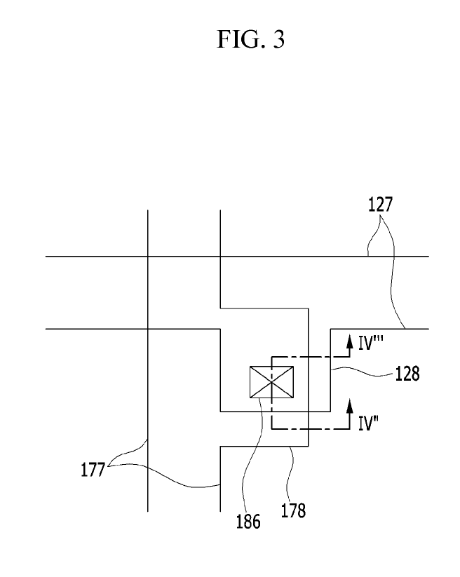

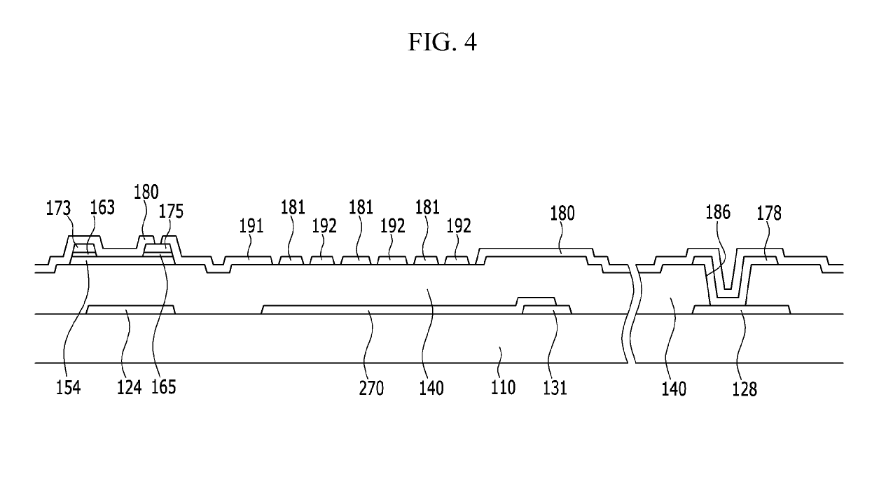

Hereinafter, a liquid crystal display according to an exemplary embodiment will be described with reference to FIG. 1 to FIG. 4. FIG. 1 is a layout view of a liquid crystal display according to an exemplary embodiment, and FIG. 2 is a layout view of a display region of the liquid crystal display of FIG. 1. FIG. 3 is a layout view of a peripheral region of the liquid crystal display of FIG. 1, and FIG. 4 is a cross-sectional view taken along a line IV-IV′ of FIG. 2 and a line IV″-IV′″ of FIG. 3.

Referring to FIG. 1, the liquid crystal display 300 according to an exemplary embodiment of the present invention includes a display region DA at which a plurality of pixels PX are formed, and a peripheral region that is positioned around the display region DA.

Hereinafter, the display region DA of the liquid crystal display 300 according to the exemplary embodiment will be described with reference to FIG. 2 and FIG. 4.

A plurality of gate lines 121 and common voltage lines 131 are formed on a first substrate 110.

Each of the gate lines 121 includes a plurality of gate electrodes 124.

The common voltage lines 131 are connected to a plurality of pixel areas to apply common voltages to a plurality of common electrodes disposed in the pixels.

A common electrode 270 may be formed immediately on the common voltage lines 131. The common electrode 270 is disposed between two adjacent gate lines 121, and is formed immediately on the common voltage line 131.

A gate insulating layer 140 is formed on the gate lines 121, the common voltage lines 131, and the common electrodes 270. The gate insulating layer 140 may be an inorganic insulator such as a silicon nitride (SiNx) or a silicon oxide (SiOx).

A semiconductor 154 is formed on the gate insulating layer 140, and ohmic contacts 163 and 165 are formed on the semiconductor 154. The semiconductor 154 may include an oxide semiconductor. In the case where the semiconductor 154 is the oxide semiconductor, the ohmic contacts 163 and 165 may be omitted.

A data line 171, a source electrode 173, and a drain electrode 175 are formed on the ohmic contacts 163 and 165.

The data line 171 serves to transfer a data signal and mainly extends in a vertical direction to cross the gate line 121. The source electrode 173 is extended from the data line 171 to be connected to the data line 171.

A passivation layer 180 and a pixel electrode 191 are formed on the data line 171, the source electrode 173, and the drain electrode 175. The pixel electrode 191 is formed immediately on a portion of the drain electrode 175, to be connected to the drain electrode 175.

The pixel electrode 191 includes a plurality of first openings 91 and a plurality of first branch electrodes 192 that are defined by the first openings 91.

The passivation layer 180 is formed at a position that does not overlap the pixel electrode 191, and includes a plurality of first insulation portions 181 that are overlapped with the first openings 91 of the pixel electrode 191.

Although not illustrated, the liquid crystal display according to the present exemplary embodiment including the first substrate 110 further includes a second substrate, and a liquid crystal layer injected between the first substrate 110 and the second substrate.

The liquid crystal layer interposed between the first substrate 110 and the second substrate includes liquid crystal molecules (not shown), and the liquid crystal molecules may be aligned such that long axes thereof are horizontal with respect to the surfaces of the first substrate 110 and the second substrate in a state where no electric field is generated.

In accordance with the liquid crystal display according to the exemplary embodiment, it is possible to form a common electrode and a pixel electrode on one substrate without increasing the number of masks by forming the common electrode below a gate insulating layer, forming the pixel electrode immediately on the gate insulating layer, and forming a passivation layer at a position to not overlap the pixel electrode.

Hereinafter, the peripheral region PA of the liquid crystal display 300 according to an exemplary embodiment 300 will be described with reference to FIG. 3 and FIG. 4.

Referring to FIG. 3 and FIG. 4, a first driving signal line 127 is formed at the same layer as that of the gate line 121 together therewith on the first substrate 110. The first driving signal line 127 includes a first extension 128.

The gate insulating layer 140 is formed on the first driving signal line 127.

A first contact hole 186 is formed in the gate insulating layer 140 to partially expose the first driving signal line 127.

A second driving signal line 177 is formed at the same layer as that of the data line 171 together therewith on the gate insulating layer 140. The second driving signal line 177 includes a second extension 178.

The second extension 178 of the second driving signal line 177 is directly connected to the first extension 128 of the first driving signal line 127 through the first contact hole 186 of the gate insulating layer 140.

As such, the first driving signal line 127 formed at the same layer as that of the gate line 121 is directly connected to the second driving signal line 177 formed at the same layer as that of the data line 171 through the first contact hole 186 at the gate insulating layer 140, and the first driving signal line 127 is covered and protected by the second driving signal line 177. Accordingly, the first driving signal line 127 can be protected from damage by an etchant for forming a pixel electrode during a process for forming a pixel electrode.

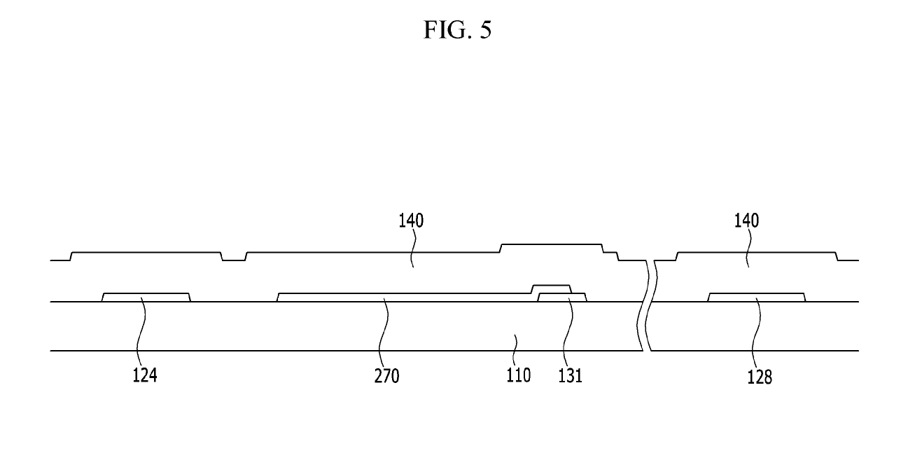

Hereinafter, a manufacturing method of liquid crystal display according to an exemplary embodiment will be described with reference to FIG. 5 to FIG. 13 as well as FIG. 2 to FIG. 4. FIG. 5 to FIG. 13 are stepwise cross-sectional views illustrating a manufacturing method of a liquid crystal display according to an exemplary embodiment, along the line IV-IV′ of FIG. 2 and the line IV″-IV′″ of FIG. 3.

Referring to FIG. 5, a plurality of gate lines 121, common voltage lines 131, and first driving signal lines 127 are formed on the first substrate 110.

A common electrode 270 is formed immediately on the common voltage lines 131, and a gate insulating layer 140 is formed on the gate line 121, the common voltage lines 131, the common electrodes 270, and the first driving signal lines 127.

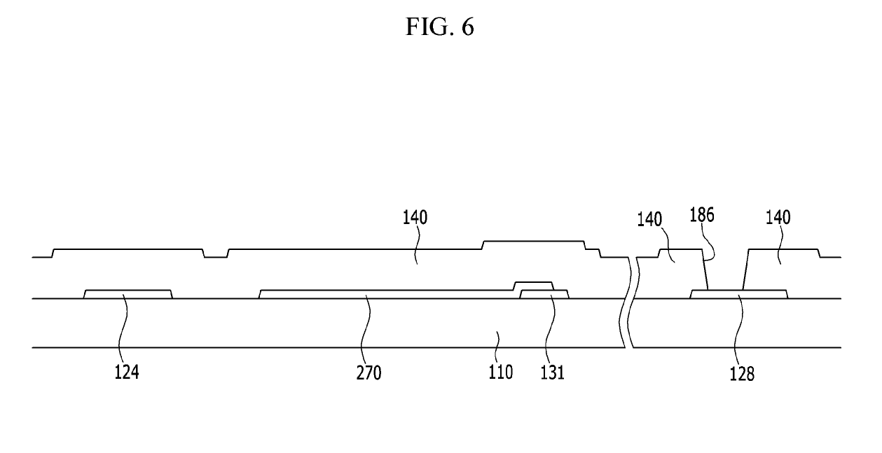

Referring to FIG. 6, a first contact hole 186 is formed in the gate insulating layer 140 to partially expose the first extension 128 of the first driving signal line 127.

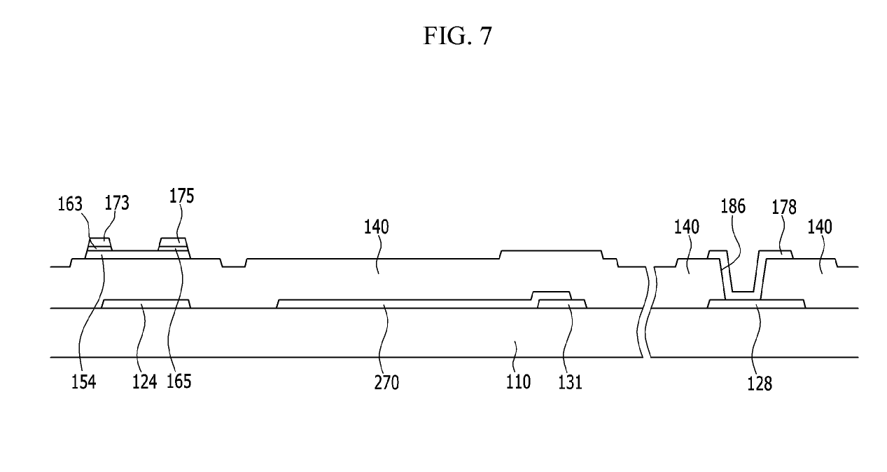

As shown in FIG. 7, a semiconductor 154 is formed on the gate insulating layer 140, ohmic contacts 163 and 165 are formed on the semiconductor 154, and a data line 171, a source electrode 173, and a drain electrode 175 are formed on the ohmic contacts 163 and 165, and a second driving signal line 177 including a second extension 178 is formed. The second extension 178 of the second driving signal line 177 is formed to cover the first extension 128 of the first driving signal line 127 which is exposed through the first contact hole 186 of the gate insulating layer 140, and thus the second extension 178 of the second driving signal line 177 is directly connected to the first extension 128 of the first driving signal line 127 through the first contact hole 186 of the gate insulating layer 140.

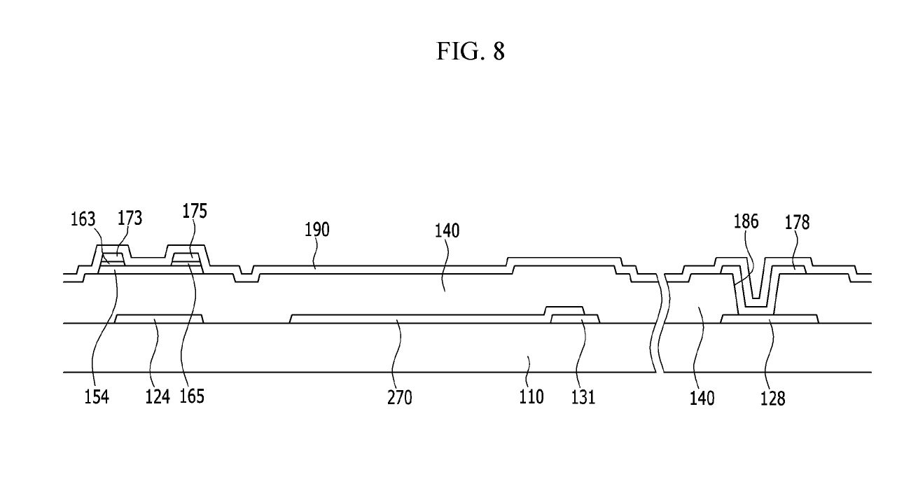

Next, as shown in FIG. 8, a conductive layer 190 is disposed on an entire surface of the first substrate 110.

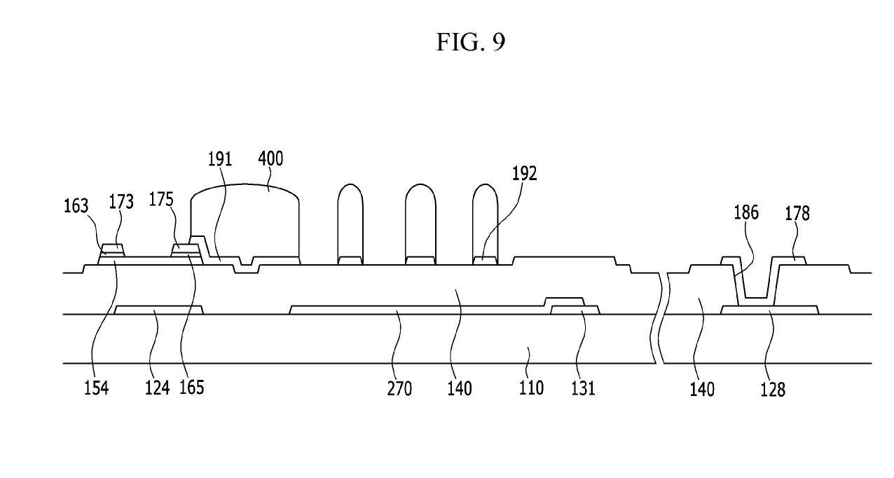

As shown in FIG. 9, a first photosensitive film pattern 400 is formed at a portion of the conductive layer 190, and then a pixel electrode 191 including a plurality of first branch electrodes 192 that are defined by a plurality of first openings 91 is formed immediately on a portion of the drain electrode 175 by etching the conductive layer 190 with the first photosensitive film pattern 400 as a mask.

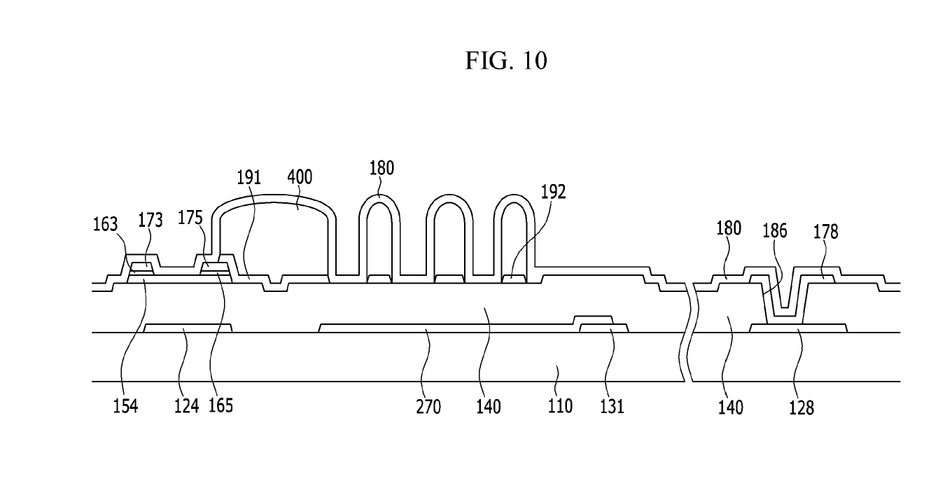

Next, as shown in FIG. 10, a passivation layer 180 is disposed on an entire surface of the first substrate 110 at which the first photosensitive film pattern 400 is formed.

Finally, the first photosensitive film pattern 400 is removed. At this time, the passivation layer 180 formed on the first photosensitive film pattern 400 is also removed, such that only the part of the passivation layer 180 that was not on the photosensitive film pattern 400 remains. This way, the passivation layer 180 is formed. In this case, as shown in FIG. 4, the passivation layer 180 is formed while avoiding any overlap with the pixel electrode 191. The passivation layer 180 includes a plurality of first insulation portion 181 that are overlapped with the first openings 91 of the pixel electrode 191.

In accordance with the manufacturing method of the liquid crystal display according to the exemplary embodiment, it is possible to form a common electrode and a pixel electrode on one substrate without increasing the number of masks by forming the common electrode below a gate insulating layer, forming the pixel electrode immediately on the gate insulating layer, and forming a passivation layer at a position that does not overlap the pixel electrode.

Further, the first driving signal line 127 formed at the same layer as that of the gate line 121 is directly connected to the second driving signal line 177 formed at the same layer as that of the data line 171 through the first contact hole 186 at the gate insulating layer 140, and the first driving signal line 127 is covered and protected by the second driving signal line 177. Accordingly, the first driving signal line 127 can be protected from any damage by an etchant for forming a pixel electrode during a process for forming a pixel electrode.

Hereinafter, a liquid crystal display according to an exemplary embodiment of the present invention will be described with reference to FIG. 1 to FIG. 3 and FIG. 11.

Referring to FIG. 1 to FIG. 3 and FIG. 11, the liquid crystal display according to the present exemplary embodiment is similar to the liquid crystal display according to the exemplary embodiment of FIG. 1 to FIG. 4. Detailed description of the same constituent elements is omitted.

However, in the liquid crystal display according to the present exemplary embodiment, a protective member 197 is further formed on the second extension 178 of the second driving signal line 177, and at the same layer as that of the pixel electrode 191. The protective member 197 is formed between the passivation layer 180 and the second extension 178 of the second driving signal line 177.

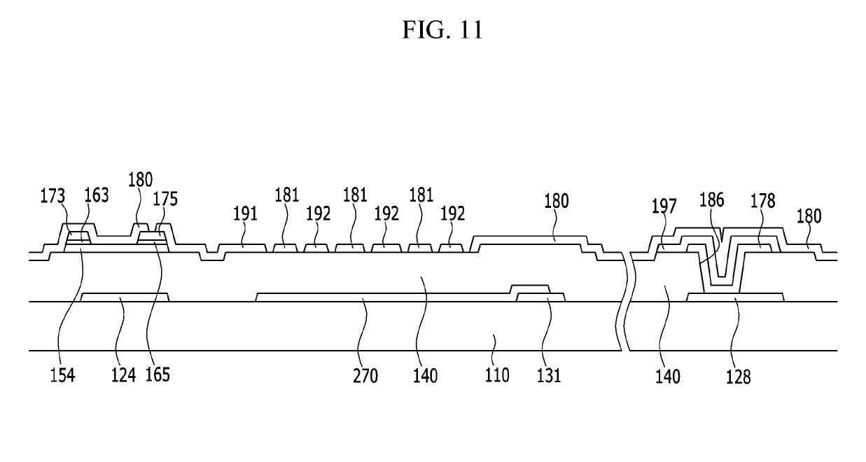

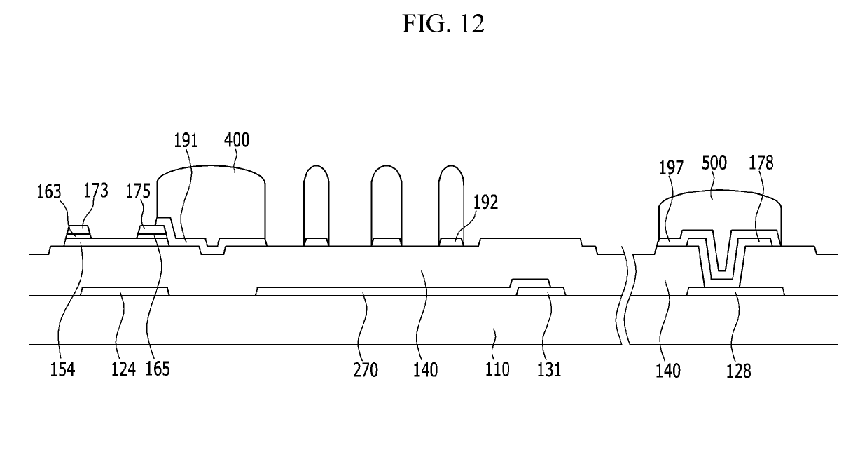

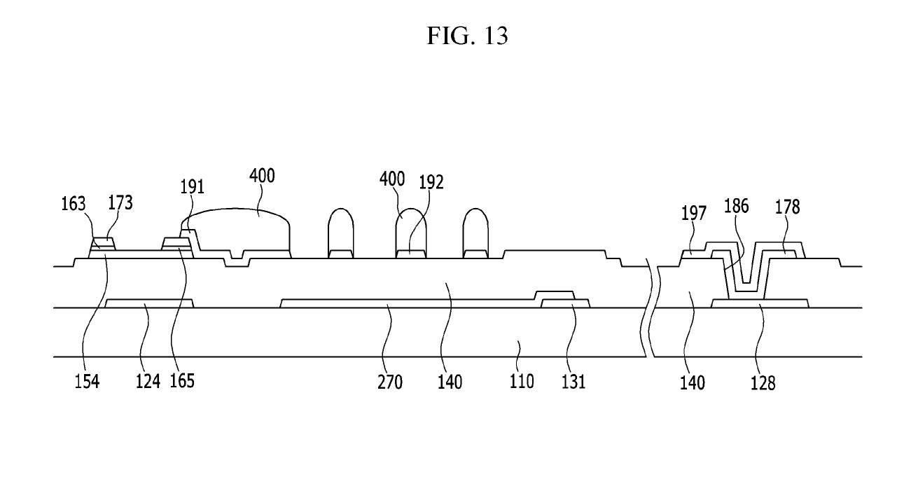

Hereinafter, a manufacturing method of a liquid crystal display according to an exemplary embodiment will be described with reference to FIG. 12 and FIG. 13 as well as FIG. 1 to FIG. 3, FIG. 5 to FIG. 8, and FIG. 11.

Referring to FIG. 5, a plurality of gate lines 121, common voltage lines 131, and first driving signal lines 127 are formed on the first substrate 110.

A common electrode 270 is formed immediately on the common voltage lines 131, and a gate insulating layer 140 is formed on the gate line 121, the common voltage lines 131, the common electrodes 270, and the first driving signal lines 127.

Referring to FIG. 6, a first contact hole 186 is formed in the gate insulating layer 140 to partially expose the first extension 128 of the first driving signal line 127.

As shown in FIG. 7, a semiconductor 154 is formed on the gate insulating layer 140, ohmic contacts 163 and 165 are formed on the semiconductor 154, and a data line 171, a source electrode 173, and a drain electrode 175 are formed on the ohmic contacts 163 and 165, and a second driving signal line 177 including a second extension 178 is formed. The second extension 178 of the second driving signal line 177 is formed to cover the first extension 128 of the first driving signal line 127 which is exposed through the first contact hole 186 of the gate insulating layer 140, and thus the second extension 178 of the second driving signal line 177 is directly connected to the first extension 128 of the first driving signal line 127 through the first contact hole 186 of the gate insulating layer 140.

Next, as shown in FIG. 8, a conductive layer 190 is disposed on an entire surface of the first substrate 110.

As shown in FIG. 12, a first photosensitive film pattern 400 and a second photosensitive film pattern 500 are formed on the conductive layer 190. Thicknesses of the first photosensitive film pattern 400 and the second photosensitive film pattern 500 are different from each other. For example, the first photosensitive film pattern 400 may be thicker than that of the second photosensitive film pattern 500.

A pixel electrode 191 including a plurality of first branch electrodes 192 that are defined by a plurality of first openings 91 is formed immediately on a portion of the drain electrode 175 by etching the conductive layer 190 with the first photosensitive film pattern 400 and the second photosensitive film pattern 500 as masks, and the protective member 197 is formed on the second extension 178 of the second driving signal line 177.

Next, as shown in FIG. 13, some of the first photosensitive film pattern 400 and all of the second photosensitive film pattern 500 is removed by performing ashing thereon.

Thereafter, a passivation layer 180 is formed on an entire surface of the first substrate 110 in which the first photosensitive film pattern 400, and the first photosensitive film pattern 400 and the passivation layer 180 formed on the first photosensitive film pattern 400 are removed together, thereby forming the passivation layer 180. In this case, as shown in FIG. 11, the passivation layer 180 is formed at a position that does not overlap the pixel electrode 191 on the protective member 197, and includes a plurality of first insulation portions 181 that are overlapped with the first openings 91 of the pixel electrode 191.

In accordance with the manufacturing method of the liquid crystal display according to the exemplary embodiment, it is possible to form a common electrode and a pixel electrode on one substrate without increasing the number of masks by forming the common electrode below a gate insulating layer, forming the pixel electrode immediately on a portion of the drain electrode, and forming a passivation layer at a position to not overlap the pixel electrode.

Further, the first driving signal line 127 formed at the same layer as that of the gate line 121 is directly connected to the second driving signal line 177 formed at the same layer as that of the data line 171 through the first contact hole 186 at the gate insulating layer 140, and the first driving signal line 127 is covered and protected by the second driving signal line 177. Accordingly, the first driving signal line 127 can be protected from any damaged by an etchant for forming a pixel electrode during a process for forming a pixel electrode.

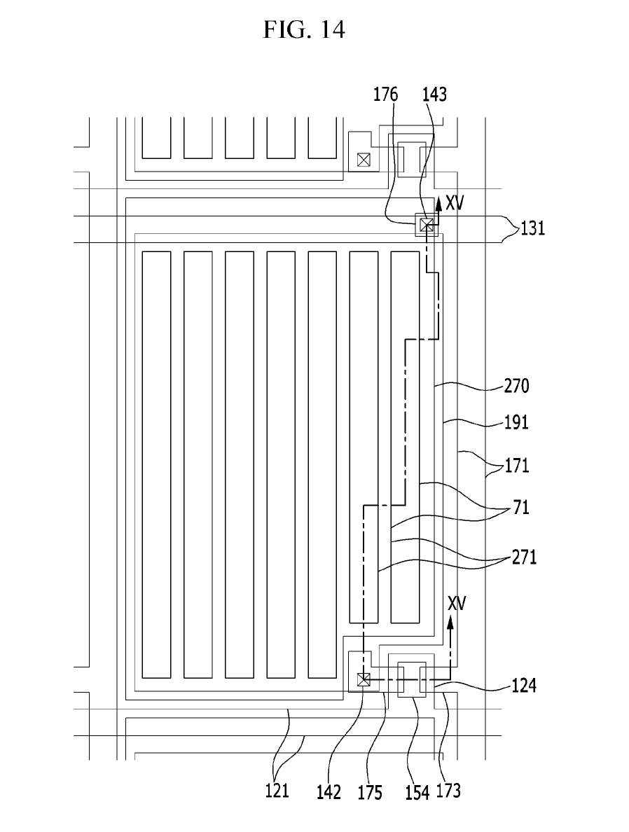

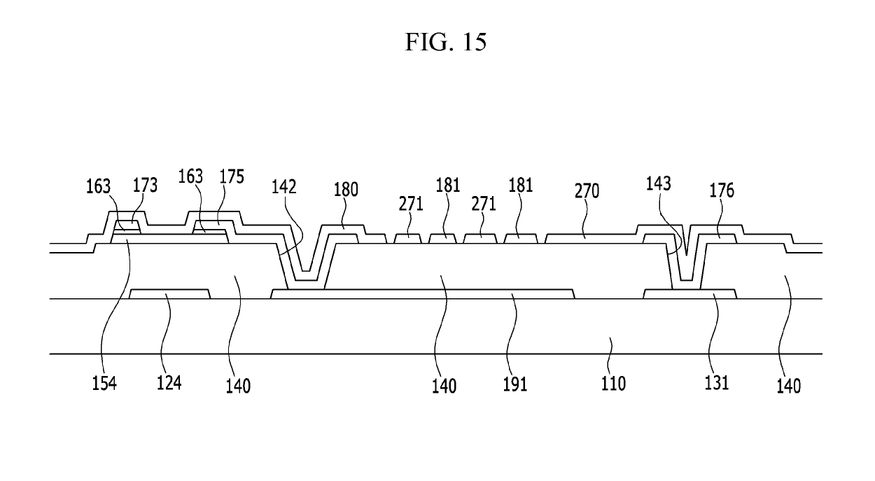

Hereinafter, a display region of a liquid crystal display according to an exemplary embodiment reference to FIG. 14 and FIG. 15

FIG. 14 is a layout view of a liquid crystal display according to an exemplary embodiment, and FIG. 15 is a cross-sectional view illustrating the liquid crystal display of FIG. 14, taken along a line XV-XV.

A plurality of gate lines 121, common voltage lines 131, and pixel electrodes 191 are formed on the first substrate 110.

Each of the gate lines 121 includes a plurality of gate electrodes 124.

The common voltage line 131 is connected to a plurality of pixel areas to apply a common voltage to a plurality of common electrodes disposed in the pixels.

A gate insulating layer 140 is formed on the gate lines 121, the common voltage lines 131, and the pixel electrode 191.

The gate insulating layer 140 includes a second contact hole 142 for partially exposing the pixel electrode 191 and a third contact hole 143 for partially exposing the common voltage line 131.

A semiconductor 154 is formed on the gate insulating layer 140, and ohmic contacts 163 and 165 are formed on the semiconductor 154. The semiconductor 154 may include an oxide semiconductor. In the case where the semiconductor 154 is the oxide semiconductor, the ohmic contacts 163 and 165 may be omitted.

A data line 171, a source electrode 173, a drain electrode 175, and connecting member 176 are formed on the ohmic contacts 163 and 165.

The data line 171 serves to transfer a data signal and mainly extends in a vertical direction to cross the gate line 121. The source electrode 173 extends from the data line 171 to be connected to the data line 171.

The drain electrode 175 is formed at a portion of the pixel electrode 191 that is exposed by the second contact hole 142, to connect the drain electrode 175 and the pixel electrode 191.

The connecting member 176 is formed at a portion of the common voltage line 131 that is exposed through the third contact hole 143.

A common electrode 270 and a passivation layer 180 are formed on the gate insulating layer 140.

The common electrode 270 includes a plurality of second openings 71 and a plurality of second branch electrodes 271 that are defined by the second openings 71.

The common electrode 270 is formed immediately on the connecting member 176 to be connected to the common voltage line 131 through the connecting member 176.

The passivation layer 180 is formed at a position that does not overlap the common electrode 270, and includes a plurality of first insulation portions 181 which are overlapped with the second openings 71.

Although not illustrated, the liquid crystal display according to the present exemplary embodiment including the first substrate 110 further includes a second substrate, and a liquid crystal layer injected between the first substrate 110 and the second substrate.

The liquid crystal layer interposed between the first substrate 110 and the second substrate includes liquid crystal molecules (not shown), and the liquid crystal molecules may be aligned such that long axes thereof are horizontal with respect to the surfaces of the first substrate 110 and the second substrate in a state where no electric field is generated.

In accordance with the liquid crystal display according to the exemplary embodiment, it is possible to form a common electrode and a pixel electrode on one substrate without increasing the number of masks by forming the common electrode below a gate insulating layer, forming the pixel electrode immediately on the gate insulating layer, and forming a passivation layer at a position to not overlap the pixel electrode.

Many characteristics of the liquid crystal displays according to the previously described exemplary embodiments may be applied to the liquid crystal display of the present exemplary embodiment.

While this inventive concept has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

### DESCRIPTION OF SYMBOLS

| | |
|---|---|
| 110: first substrate | 121: gate line |
| 127: first driving signal line | 131: common voltage line |
| 140: gate insulating layer | 154: semiconductor |
| 171: data line | 173: source electrode |
| 175: drain electrode | 176: connecting member |
| 177: second driving signal line | 180: passivation layer |
| 197: protective member | 270: common electrode |
| 71, 91: opening | DA: display region |
| PA: peripheral region | PX: pixel |

What is claimed is:

1. A liquid crystal display comprising:
a substrate;
a gate line and a first electrode formed on the substrate;
a gate insulating layer formed on the gate line and the first electrode;
a second electrode formed on the gate insulating layer, and including a plurality of openings and a plurality of branch electrodes that are defined by the openings; and
a passivation layer formed on the gate insulating layer to overlap the openings of the second electrode.

2. The liquid crystal display of claim 1, further comprising:
a data line, a source electrode, and a drain electrode formed on the gate insulating layer;
a first driving signal line formed at a same layer as that of the gate line; and
a second driving signal line formed at a same layer of the data line,
wherein the second driving signal line is directly connected to the first driving signal line through a first contact hole formed at the gate insulating layer.

3. The liquid crystal display of claim 2, further comprising
a protective member formed on the second driving signal line, and formed at a same layer as that of the second electrode.

4. The liquid crystal display of claim 1, further comprising
a common voltage line formed on the substrate,
wherein the second electrode is formed on a portion of the drain electrode, and
the first electrode is formed on the common voltage line.

5. The liquid crystal display of claim 1, further comprising:
a data line, a source electrode, and a drain electrode formed on the gate insulating layer; and
a common voltage line formed on the substrate,
wherein the gate insulating layer includes a first contact hole extending to the first electrode and a second contact hole extending to the common voltage line,
the drain electrode is connected to the first electrode through the first contact hole, and
the second electrode is connected to the common voltage line through the second contact hole.

6. A manufacturing method of a liquid crystal display, the method comprising:
forming a gate line and a first electrode on a substrate;
forming a gate insulating layer on the gate line and the first electrode;
forming a second electrode on the gate insulating layer, the second electrode including a plurality of openings and a plurality of branch electrodes that are defined by the openings; and
forming a passivation layer on the gate insulating layer to overlap the openings of the second electrode.

7. The manufacturing method of claim 6, wherein the forming of the second electrode and the forming of the passivation layer are performed by using one photosensitive film pattern.

8. The manufacturing method of claim 7, wherein the forming of the second electrode and the forming of the passivation layer include:
disposing a conductive layer on the gate insulating layer;
forming a photosensitive film pattern on the conductive layer;
forming the second electrode by etching the conductive layer with the photosensitive film pattern as a mask;
disposing a passivation layer on the photosensitive film pattern; and
removing the photosensitive film pattern with the passivation layer formed on the photosensitive film pattern.

9. The manufacturing method of claim 8, further comprising:
forming a data line, a source electrode, and a drain electrode on the gate insulating layer;
forming a first driving signal line at a same layer as that of the gate line; and
forming a second driving signal line at a same layer as that of the data line,
wherein the forming of the gate insulating layer includes forming a first contact hole to partially expose the first driving signal line, and
the second driving signal line is directly connected to the first driving signal line through the first contact hole.

10. The manufacturing method of claim 9, further comprising:
forming a protective member on the second driving signal line and at a same layer as that of the second electrode.
